(19) United States
(12) Patent Application Publication
(10) Pub. No.: US 2009/0183372 A1
(43) Pub. Date: Jul. 23, 2009

(54) TOOL FOR SEVERING A HOSE SQUARE TO ITS LENGTH

(75) Inventors: Leo P. Oriet, Rochester Hills, MI (US); Jules Cazabon, Staples (CA)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/016,472

(22) Filed: Jan. 18, 2008

(51) Int. Cl. B23D 21/06; B26B 13/22

(52) U.S. Cl. 30/92; 30/233

(57) ABSTRACT

A cutting tool (10) for severing flexible hose square to the hose length has a bail (36) for holding hose in a cradle (28) so that the hose length is perpendicular to a blade (30) that severs the hose.

### FIELD OF THE INVENTION

This invention relates to a cutting tool for severing flexible hose such as pneumatic or hydraulic hose.

### BACKGROUND OF THE INVENTION

A known cutting tool for severing flexible hose comprises a cutting mechanism operated by a pair of pivotally connected handles that are squeezed together about the axis of the pivot. The cutting mechanism comprises a blade that turns with one of the handles about the pivot axis and a V-shaped cradle that turns about the pivot axis with the other handle. The cradle has a length that is parallel with the pivot axis and that is open at the ends. Medial to its lengthwise ends, the cradle has a widthwise slot whose dimension along the length of the cradle is slightly greater than the thickness of the blade. The cradle slot is in alignment with the blade to allow the blade to enter the slot as severing of a hose is being completed. The blade itself has a V-shaped cutting edge.

With the handles in position that causes the cutting mechanism to be open, hose that is to be severed is placed lengthwise in the cradle. Squeezing the handles together closes the cutting mechanism on the hose, severing the hose in the process. The pointed tip of the V-shaped cutting edge of the blade initially punctures the hose wall. Continued squeezing of the handles together causes the sides of the cutting edge to slice essentially across opposite semi-circumferences of the hose, with the pointed tip eventually puncturing the hose wall approximately diametrically opposite the initial puncture and entering the cradle slot as the severing is completed.

The finished result should be a hose that has been cut square, i.e., at a right angle to its length. However, if a hose is not properly seated in the cradle, the cut may not be square.

Experience in production operations has disclosed that hoses are on occasion not cut square. Some limited out-of-squareness of a cut may be tolerable. A more extreme amount may not.

If an unacceptable cut is discovered in a hose before it is fit to a fluid or pneumatic system, use of the hose can be avoided simply at the expense of scrapping it. If an unacceptable cut is not discovered before the hose is fit to a fluid or pneumatic system, the faulty hose may make itself apparent only after it has caused a failure in the fluid or pneumatic system in which it is being used. Apart from the scrap loss of the hose, repair and other costs, some possibly substantial, may be incurred.

Consequently, it is believed that a tool that can facilitate square severing of a hose would be a meaningful improvement.

An improvement that could be retrofitted to an existing tool would be a further advantage.

### SUMMARY OF THE INVENTION

The present invention provides such an improvement.

Briefly, the improvement is embodied by the addition of a bail to the tool described above. The bail is arranged to act on a hose placed in the cradle to cause the hose to be properly seated in the cradle for severing so as to assure a square cut. The bail can be incorporated in a new tool at time of its fabrication, and can also be added to an existing tool.

One generic aspect of the present invention relates to a cutting tool useful in severing a hose square to the hose length comprising pivotally connected handles that can be squeezed together about the axis of the pivot and a cutting mechanism that is operated by squeezing the handles together.

A blade turns with one of the handles about the pivot axis and has a V-shaped cutting edge. A V-shaped cradle that turns about the pivot axis with the other handle and has a length that is parallel with the pivot axis and that is open at at least one of two lengthwise ends. The cradle further comprises a slot that runs widthwise of the cradle perpendicular to the length of the cradle medial to the cradle's lengthwise ends. The slot is in alignment with the blade and has a dimension that as measured lengthwise of the cradle is slightly greater than the thickness of the blade, as also measured lengthwise of the cradle, to allow the blade to enter the slot when the handles are squeezed together to sever a hose seated lengthwise in the cradle.

A bail is carried by the tool for disposition overlying a hose placed in the cradle to force the hose to seat in the cradle so as to place the axis of the hose parallel to the length of the cradle preparatory to and during squeezing of the handles that forces the blade to sever the hose.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a side view of a cutting tool embodying principles of the present invention.

FIG. 2 is an enlarged view of a portion of the cutting tool with the tool turned upside down from FIG. 1.

FIG. 3 is a view similar to FIG. 2 showing the tool in use.

FIG. 4 is an enlarged view of one part of the tool, specifically a bail, shown by itself.

### DESCRIPTION OF THE PREFERRED EMBODIMENT

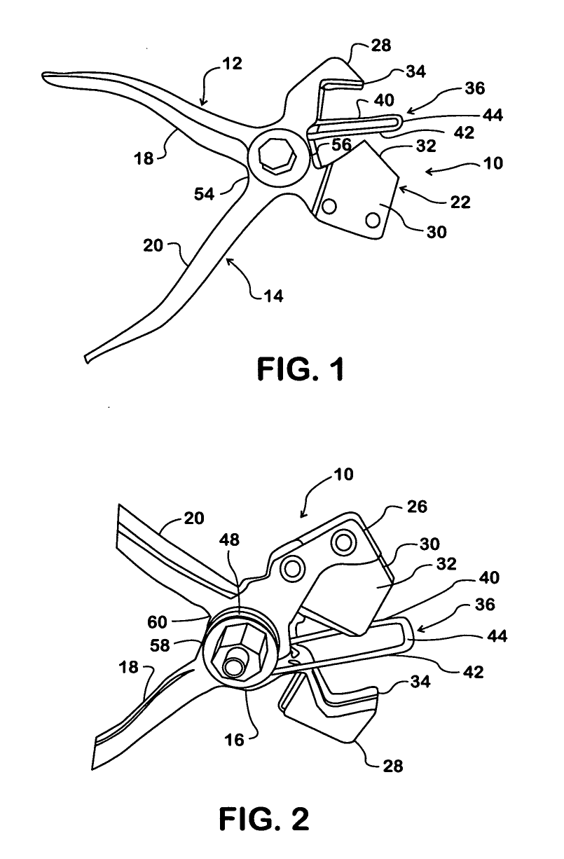

FIGS. 1-3 show a cutting tool 10 that is used for severing flexible hose, such as pneumatic or hydraulic hose. Tool 10 comprises parts 12 and 14 that are pivotally connected by a shaft 16 that passes through aligned holes in the two parts.

Parts 12 and 14 contain respective handles 18, 20 that when manually grasped and squeezed together, operate a cutting mechanism 22 disposed at an opposite side of the shaft from the handles. Cutting mechanism 22 comprises a cutting blade 30 that is replaceably mounted in a mounting 26 in part 12. The cutting mechanism further comprises a V-shaped cradle 28 that is formed in part 14. Blade 30 and cradle 28 cooperate to sever a hose placed in the cradle when handles 18, 20 are squeezed together.

Blade 30 has a body that is fastened in place on mounting 26 and that has a V-shaped cutting edge 32 pointing away from the mounting toward cradle 28.

Cradle 28 has a length that is parallel with the axis of shaft 16 about which the parts 12, 14 pivot and is open at its lengthwise ends. Cradle 28 also comprises a slot 34 that runs widthwise of the cradle perpendicular to the length of the cradle. Slot 34 is located medial to the cradle's lengthwise ends and in alignment with blade 30. Slot 34 has a dimension that as measured lengthwise of cradle 28 is slightly greater than the thickness of blade 30, as also measured lengthwise of the cradle, to allow cutting edge 32 to enter the slot when handles 18, 20 are squeezed together to sever a hose seated lengthwise in the cradle.

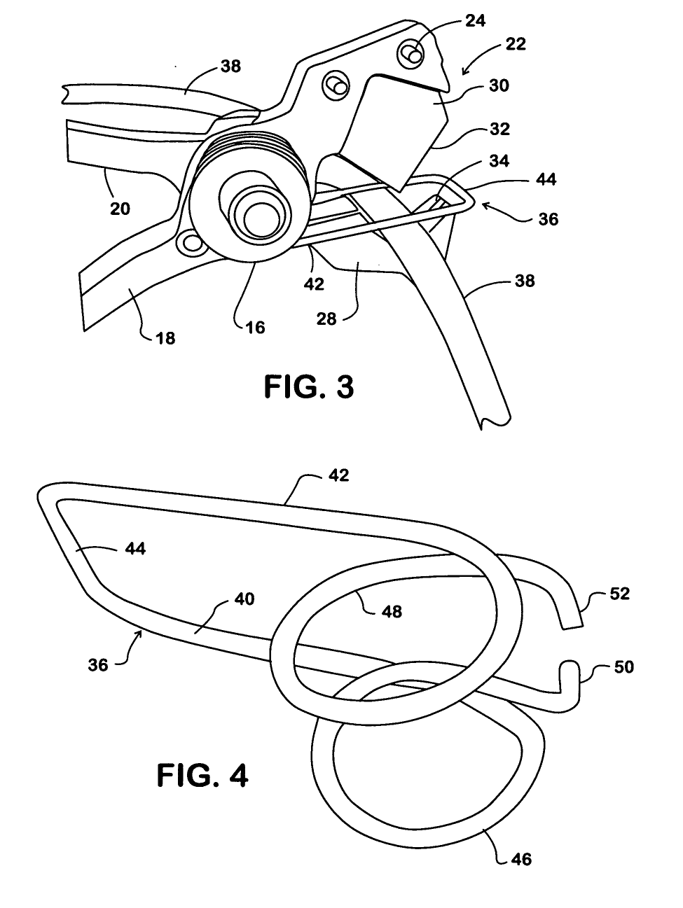

Tool 10 carries a bail 36, shown by itself in FIG. 4, that is intended to overlie a hose placed in cradle 28 for forcing the hose to seat in the cradle so that the axis of the hose is held parallel to the length of the cradle preparatory to, and during, squeezing of handles 18, 20 together for forcing blade 24 to sever the hose. FIG. 3 shows a hose 38 being held in this way prior to the pointed end of cutting edge 32 piercing the top of the hose wall.

Bail 36 is preferably fabricated from wire of circular cross section to comprise a loop having a first segment 40 that is transverse to the length of the cradle and disposed beyond one lengthwise end of the cradle, a second segment 42 that is transverse to the length of the cradle and disposed beyond the other lengthwise end of the cradle, and a third segment 44 joining the first and second segments beyond the cradle relative to the pivot axis.

Bail 36 further comprises a first spiral loop 46 that encircles the pivot axis at one side of parts 12, 14 and a second spiral loop 48 that encircles the pivot axis at an opposite side of the two parts. Segment 40 extends between spiral loop 46 and a curved bend at one end of segment 44, segment 42 extends between spiral loop 48 and a curved bend at the opposite end of segment 44. The two spiral loops are captured on opposite ends of shaft 16 by washers 54, 56, 58, 60. Shaft 16 has a head at one end and a thread at the opposite end. A nut is threaded onto the shaft thread. The head is against outermost washer at one side of the tool and the nut against the outermost washer at the opposite side to hold the washer/loop stacks secure against sides of the parts 12, 14 without significantly adding to the squeezing force that is needed to operate the tool.

Bail 36 also has inward turned tails 50, 52 at ends of the respective loops 46, 48 opposite the respective segments 40, 42. By ending each spiral loop 46, 48 in such a tail, the bail ends can be associated with part 12 by fitting each tail to a hole in part 12.

While a presently preferred embodiment of the invention has been illustrated and described, it should be appreciated that principles of the invention apply to all embodiments falling within the scope of the following claims.

What is claimed is:

1. A cutting tool useful in severing a hose square to the hose length comprising:
pivotally connected handles that can be squeezed together about the axis of the pivot;
a cutting mechanism that is operated by squeezing the handles together and that comprises a blade that turns with one of the handles about the pivot axis and has a V-shaped cutting edge, and a V-shaped cradle that turns about the pivot axis with the other handle;
the cradle having a length that is parallel with the pivot axis and that is open at at least one of two lengthwise ends, the cradle further comprising a slot that runs widthwise of the cradle perpendicular to the length of the cradle medial to the cradle's lengthwise ends and in alignment with the blade, the slot having a dimension that as measured lengthwise of the cradle is slightly greater than the thickness of the blade as also measured lengthwise of the cradle to allow the blade to enter the slot when the handles are squeezed together to sever a hose seated lengthwise in the cradle;
and a bail carried by the tool for disposition overlying a hose placed in the cradle to force the hose to seat in the cradle so as to place the axis of the hose parallel to the length of the cradle preparatory to and during squeezing of the handles that forces the blade to sever the hose.

2. A cutting tool as set forth in claim 1 in which the cradle is open at each lengthwise end, and the bail comprises a loop having a first segment that is transverse to the length of the cradle and disposed beyond one lengthwise end, a second segment that is transverse to the length of the cradle and disposed beyond the other lengthwise end, and a third segment joining the first and second segments beyond the cradle relative to the pivot axis.

3. A tool as set forth in claim 2 in which the bail comprises a first spiral loop that encircles the pivot axis at one side of the handles and a second spiral loop that encircles the pivot axis at an opposite side of the handles, the first segment extends from the first spiral loop to the third segment, the second segment extends from the second spiral loop to the third segment, and the spiral loops are captured on a shaft that extends through the handles to pivotally connect them.

4. A tool as set forth in claim 3 in which washers capture the spiral loops on the shaft.

5. A tool as set forth in claim 3 in which each spiral loop ends in a tail that fits to a hole in a part that forms one of the handles and also a mounting for the blade opposite the pivot axis relative to the one handle.

6. A tool as set forth in claim 2 in which the bail loop comprises spring metal wire of circular transverse cross section.
